(19) United States
(12) Patent Application Publication
(10) Pub. No.: US 2005/0098393 A1
(43) Pub. Date: May 12, 2005

(54) Actuator assembly for a lifter device for disabled persons on wheelchair and prams for children

(76) Inventor: Sardonico Gennaro, Beinasco (IT)

Correspondence Address: WILLIAM B. PATTERSON;MOSER, PATTERSON & SHERIDAN, L.L.P., Suite 1500, 3040 Post Oak Blvd., Houston, TX, 77056, US

(21) Appl. No.: 10/954,620

(22) Filed: Sep. 30, 2004

(30) Foreign Application Priority Data
Sep. 30, 2003 (IT) TO2003A000759

(51) Int. Cl. B66B 7/00

(52) U.S. Cl. 187/414

(57) ABSTRACT

An actuator assembly for a lifter device for disabled persons on wheelchair and prams for children comprising a vertically movable platform able to move between a lowered position and a raised position to overcome a difference in level of access. The actuator assembly comprises an electric motor and a transmission device including a chain of transmission members, provided exclusively with rotary motion.

### CROSS-REFERENCE TO RELATED APPLICATIONS

This application claims benefit of Italian patent application number TO2003A000759, filed Sep. 30, 2003, which is herein incorporated by reference.

### BACKGROUND OF THE INVENTION

1. Field of the Invention

The present invention relates in general to lifter devices and in particular it pertains to equipment to facilitate the access of disabled persons and children's prams aboard vehicles, for example collective transport vehicles, or to fixed installations such as public buildings, museums and the like.

2. Description of the Related Art

The invention can be applied in particular to a lifter device to be permanently applied to a vehicle or to a fixed installation to overcome a difference in level to access said vehicle or said fixed installation. The present invention can nonetheless be applied more in general to lifter devices of various kinds for persons or for loads, in vehicles or in private, commercial or industrial buildings. The invention can, for example, be applied in lifter devices under the body or over the body for automobiles or buses, in lifter devices over the box or under the box for trains, in buildings such as shopping centres or the like.

The main drawback in actuators for known lifter devices consists of the possibility of sticking and blocking of the vertical actuation system of the lifting platform, in particular if the load on the platform is displaced on one side.

The object of the present invention is to provide an actuator assembly for lifter devices which is simple, robust and reliable and which allows to avoid risks of sticking.

### SUMMARY OF THE INVENTION

According to the present invention, said object and other objects are achieved by an actuator assembly having the characteristics set out in the claims.

### BRIEF DESCRIPTION OF THE DRAWINGS

The characteristics and advantages of the present invention shall become readily apparent in the detailed description that follows, provided purely by way of non limiting example, with reference to the accompanying drawings, in which:

FIG. 1 is a schematic perspective view of an actuator assembly according to the present invention,

FIG. 2 is a lateral view according to the arrow 11 of FIG. 1,

FIG. 3 is a perspective view of a first embodiment of an actuator assembly according to the invention,

FIG. 4 is a perspective view of a second example of application of an actuator assembly according to the invention,

FIG. 5 is a perspective view of the part designated by the arrow V in FIG. 4, and

FIG. 6 is a perspective view of a third example of application of an actuator assembly according to the invention.

### DETAILED DESCRIPTION

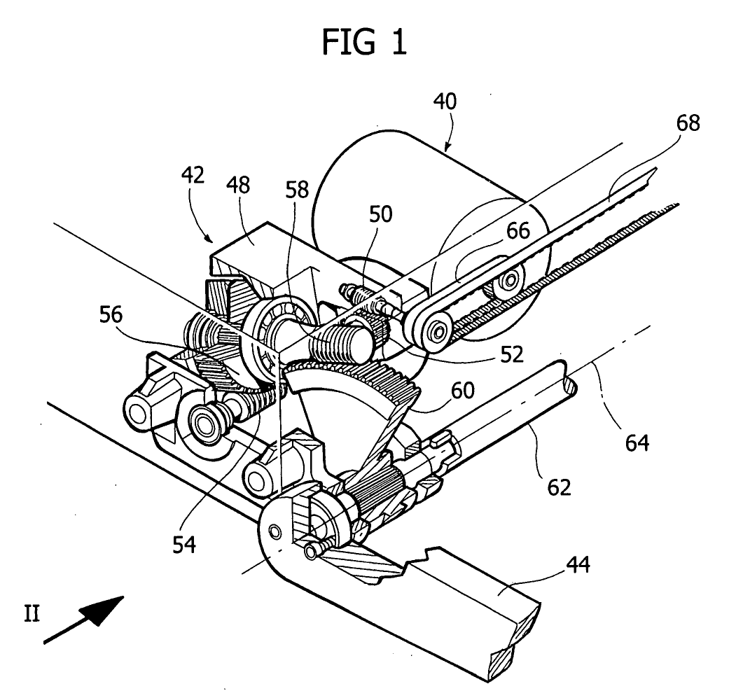

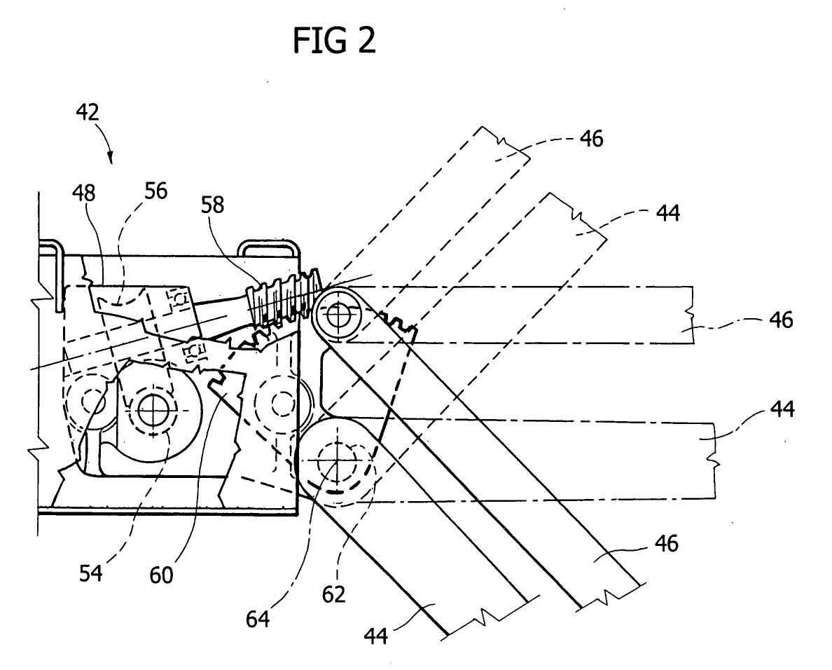

With reference to FIGS. 1 and 2, an actuator assembly according to the invention comprises an electric motor 40 and at least one transmission device 42. The or each transmission device 42 is connected to two arms 44, 46 of an articulated parallelogram device associated to a vertically movable platform.

The transmission assembly 42 comprises a fixed case 48 bearing a chain of transmission members provided exclusively with rotary motion. Each transmission device 42 comprises a first transmission mechanism with worm screw 50 and helical wheel 52. The worm screw 50 constitutes the input member of the transmission device 42. The first helical wheel 52 is integral with a shaft bearing a second worm screw 54 freely rotatable around an axis that is transverse relative to the axis of rotation of the first worm screw 50. The second worm screw 54 co-operates with a second helical wheel 56 integral with a shaft bearing a third worm screw 58 rotatable around an axis that is orthogonal relative to the axis of rotation of the second worm screw 54. The third worm screw 58 meshes with a sector of helical wheel 60 constituting the output member of the transmission device 42.

In an embodiment of the invention, two transmission devices 42 are provided, situated on two opposite sides of a vertically movable lifting platform. The toothed sector 60 is keyed onto a transverse synchronisation shaft 62 mounted oscillating relative to the case 48 of the transmission device 42 around a horizontal case 64. The toothed sector 60 is integral with the lower arm 44 of the articulated parallelogram device. The transverse shaft 62 mutually connects the toothed sectors 60 of two transmission assemblies 42 situated on the two sides of the platform and its purpose is mutually to synchronise the oscillation movements of the two lower arms 44. The electric motor 40 is connected to the two transmission devices 42 by means of positive drive belts 66, 68.

It is readily apparent that the rotation of the output shaft of the motor 40 causes the oscillation of the toothed sector 60 around the axis 64. The toothed sector 60 commands, through the articulated parallelogram device 44, 46, the rising or lowering of the platform.

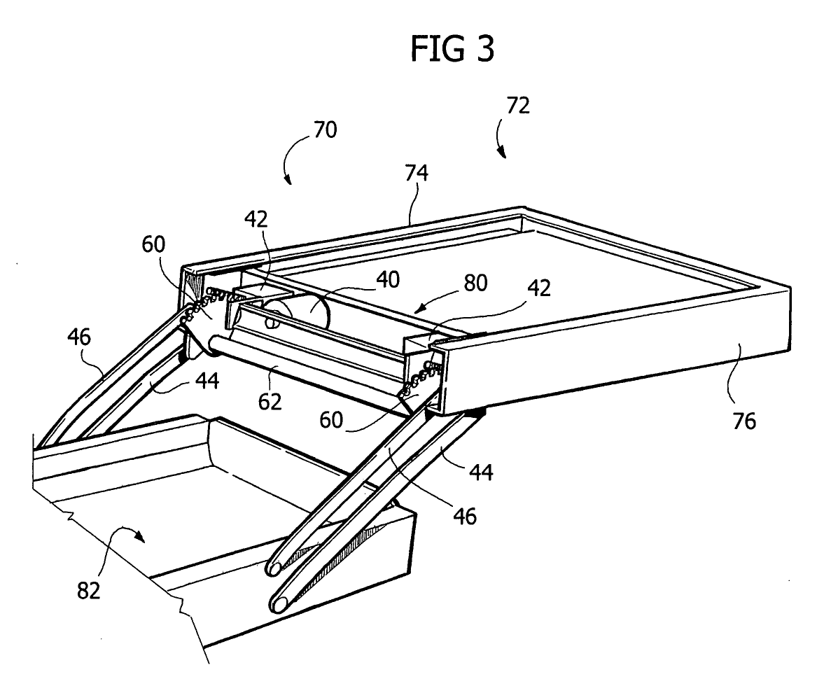

With reference to FIG. 3, the reference number 70 designates a retracting lifter device comprising a fixed frame 72 to be encased within a seat (not shown) provided below the plane of access to a vehicle or to a fixed installation. The fixed frame 72 has a general U-shaped configuration, with two parallel branches 74, 76 mutually joined by a rear branch 78.

The fixed frame 72 bears a carriage 80, movable in the longitudinal direction between an extracted position and a retracted position. The carriage 80 bears an actuator assembly according to the invention, having an electric motor 40 and two transmission devices 42. Each transmission device 42 bears two arms 44, 46 connected to a vertically movable platform 82 according to an articulated parallelogram configuration.

The transmission devices 42 according to the present invention, mutually synchronised by means of the transverse shaft 62, allow to avoid the sticking or blocking of the vertical motion of the platform 82 even under conditions in which the load on the platform 82 is laterally unbalanced.

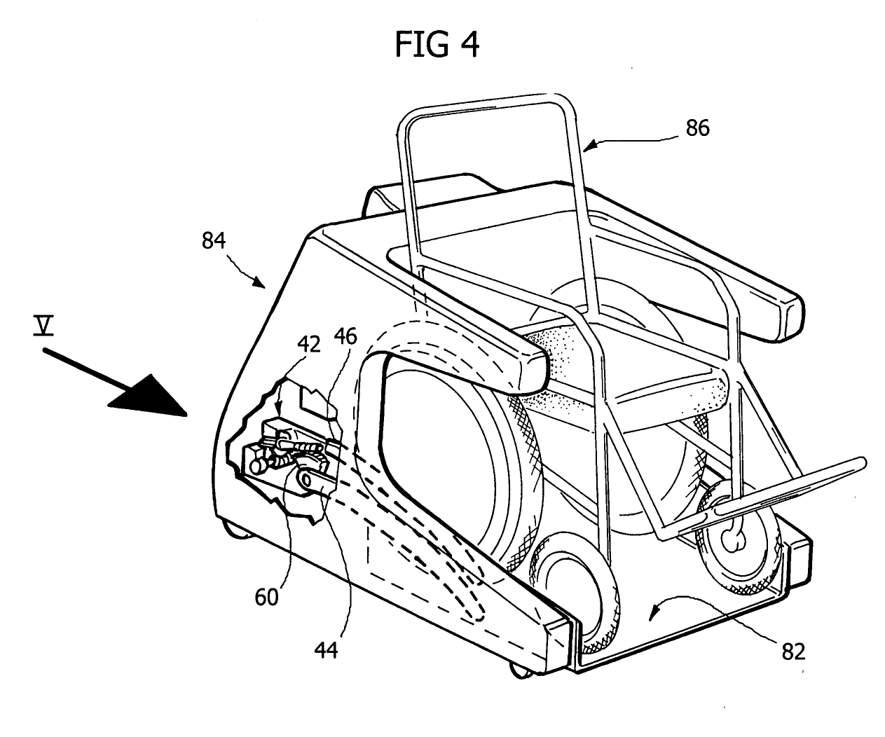

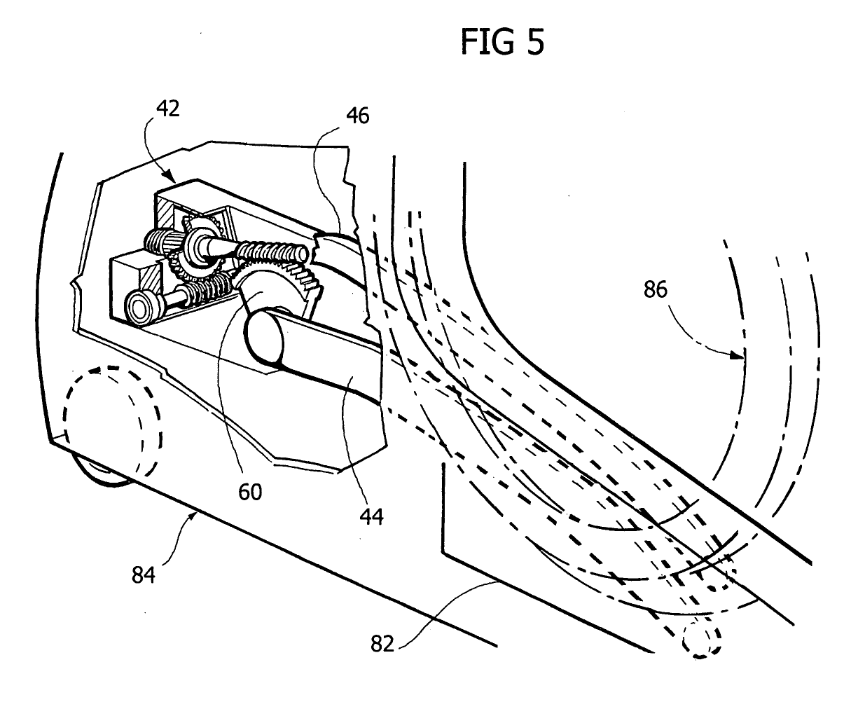

FIGS. 4 and 5 show a second example of application of an actuator assembly according to the invention. In this case, the actuator assembly 40, 42 is applied to a lifter device including a base structure 84 provided with a vertically movable platform 82 able to receive and to lift and lower a wheelchair 86. The actuator assembly 40, 42 is borne by the base structure 84 and it is connected to the vertically movable platform 82 by means of the articulated parallelogram device 44, 46.

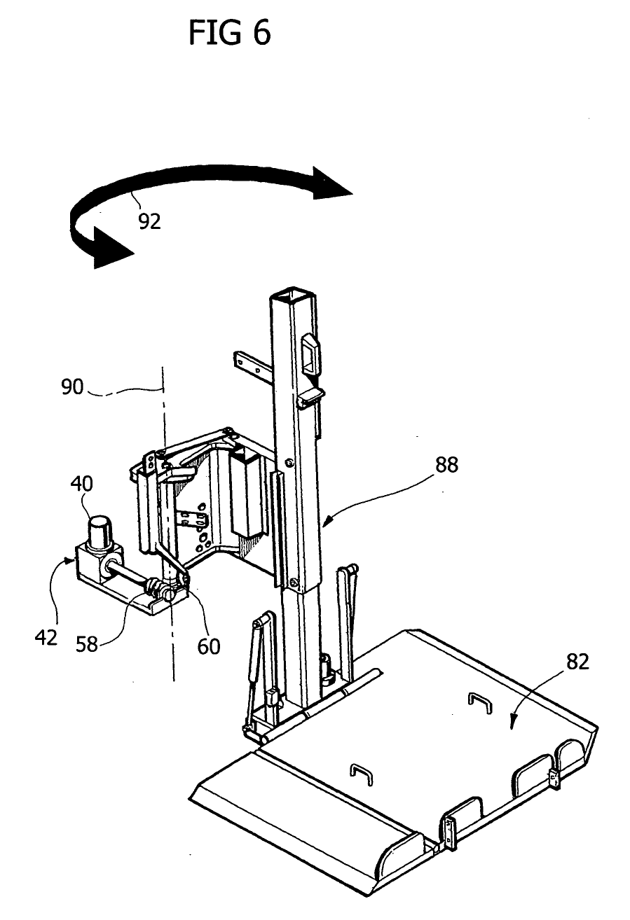

An additional example of application of the actuator assembly according to the invention is shown in FIG. 6. In this case, the actuator assembly 40, 42 is applied to a lifter device including a vertically movable platform borne by a vertical upright 88. The lifter device is mounted rotatable around a vertical axis 90 and the actuator assembly 40, 42 is used to command the rotation of the entire lifter device around the vertical axis 90 in the direction indicated by the double arrow 92 between an inoperative position and an operative position, and vice versa.

Naturally, without altering the principle of the invention, the construction details and the embodiments may be widely varied relative to what is described and illustrated herein, without thereby departing from the scope of the present invention as defined in the appended claims.

1. An actuator assembly for a lifter device for disabled persons on wheelchair and prams for children comprising a vertically movable platform able to move between a lowered position and a raised position to overcome a difference in level of access, the actuator assembly comprising an electric motor and a transmission device including a chain of transmission members, characterised in that said transmission members are provided exclusively with rotary motion.

2. Actuator assembly as claimed in claim 1, characterised in that the transmission device comprises at least one transmission mechanism with worm screw and helical wheel.

3. Actuator assembly as claimed in claim 2, characterised in that said transmission device comprises three transmission mechanisms with worm screw and helical wheel mutually connected in series.

4. Actuator assembly as claimed in claim 3, characterised in that the transmission device comprises a sector of helical wheel integral in rotation with an arm of an articulated parallelogram device.

5. Actuator assembly as claimed in claim 1, characterised in that it comprises two transmission devices positioned at respective sides of the platform.

6. Actuator assembly as claimed in claim 5, characterised in that each transmission device is connected to a pair of arms arranged according to an articulated parallelogram configuration.

7. Actuator assembly as claimed in claim 5, characterised in that it comprises a synchronisation shaft which mutually connects the output members of the two transmission mechanisms.
